(19) United States
(12) Patent Application Publication
(10) Pub. No.: US 2015/0344009 A1
(43) Pub. Date: Dec. 3, 2015

(54) HYDRAULIC ANTI-LOCK BRAKING SYSTEM FOR A TWO-WHEELER

(71) Applicant: ROBERT BOSCH GMBH, Stuttgart (DE)

(72) Inventors: Karl Hagspiel, Immenstadt (DE); Matthias Hurst, Immenstadt (DE); Andreas Weh, Sulzberg (DE)

(21) Appl. No.: 14/760,167

(22) PCT Filed: Nov. 21, 2013
(86) PCT No.: PCT/EP2013/074343

§ 371 Date: Jul. 9, 2015

(30) Foreign Application Priority Data
Jan. 14, 2013 (DE) 10 2013 200 422.2

(51) Int. Cl. B60T 8/17; B60T 8/176; B62L 3/02

(52) U.S. Cl. CPC B60T 8/1706; B62L 3/023; B60T 8/176

(57) ABSTRACT

A hydraulic anti-lock braking system for a two-wheel vehicle includes: an inlet valve for connecting and disconnecting a hydraulic connection between a brake actuating device and a wheel brake; an accumulator for accommodating brake fluid from the hydraulic connection between the inlet valve and the wheel brake; and an outlet valve for connecting and disconnecting the accumulator to and from the wheel brake. The accumulator is designed to return brake fluid into the hydraulic connection between the inlet valve and the wheel brake.

### BACKGROUND OF THE INVENTION

1. Field of the Invention

The present invention relates to a hydraulic anti-lock braking system for a two-wheeler and to a method for controlling a hydraulic anti-lock braking system.

2. Description of the Related Art

A bicycle anti-lock braking system is able to increase the safety of the bicyclist and the other road users. For example, bicycle anti-lock braking systems which control the braking force mechanically with the aid of cables are known.

The growing market of electrically driven bicycles (so-called e-bikes) and the associated constant availability of electrical energy on the bicycle offer new possibilities for active bicyclist protection. The electric motor assistance of the bicyclist additionally, in principle, increases the average speed, and moreover also allows less experienced bicyclists to achieve destinations at higher altitudes.

In the motorcycle field, anti-lock braking systems are known which operate analogously to motor vehicle anti-lock braking systems using a return principle. The brake fluid is delivered from the brake back in the direction of the brake lever with the aid of a pump and a motor.

### BRIEF SUMMARY OF THE INVENTION

It is the object of the present invention to provide an energy-saving anti-lock braking system for a two-wheeler which has a simple design and is low-maintenance.

One aspect of the present invention relates to a hydraulic anti-lock braking system for a two-wheeler, for example for an e-bike or a moped.

According to one specific embodiment of the present invention, the anti-lock braking system includes an inlet valve for connecting and disconnecting a hydraulic connection between a brake actuating device and a wheel brake; an accumulator or intermediate accumulator for accommodating brake fluid from the hydraulic connection between the inlet valve and the wheel brake; and an outlet valve for connecting and disconnecting the accumulator to and from the wheel brake.

The brake actuating device, which is attached to the handlebar of the two-wheeler, for example, may include a brake lever, which may be used to increase a pressure in a piston. The piston may be connected via a hydraulic connection to a wheel brake, in which a brake cylinder presses brake shoes against a brake disk or a wheel rim as a result of the hydraulic pressure, for example. An inlet valve is situated in the hydraulic connection (which may include one or multiple hydraulic lines) and may be used to prevent a pressure on the wheel brake from being increased further with the aid of the brake actuating device. The pressure on the wheel brake may be reduced via an outlet valve by being able to discharge brake fluid into an accumulator via the opened outlet valve. The accumulator may provide a variable volume, for example with the aid of a piston in a cylinder.

The accumulator is designed to return brake fluid into the hydraulic connection between the inlet valve and the wheel brake, for example by reducing its variable volume. For example, the accumulator may be emptied again by pushing back the piston.

In general, the accumulator may temporarily store the pressure present during filling and use it to automatically empty itself again.

The brake fluid is thus not delivered into the hydraulic connection between the brake actuating device and the inlet valve, but is returned to where it was withdrawn from the hydraulic connection. In this way, additional lines may be dispensed with.

A hydraulic anti-lock braking system may result in the advantages of shorter response times and lower maintenance compared to a cable-based mechanical anti-lock braking system. Moreover, a hydraulic anti-lock braking system may be adapted to existing hydraulic brakes.

Compared to an anti-lock braking system using the return principle, less electrical energy is required since only the valves have to be switched. This may result in a lower box volume and a lower weight. Since a pump having an associated motor may be dispensed with, lower costs may result.

The inlet valve, the outlet valve, and the accumulator may be combined to form a shared regulating module, which provides a shared housing for these components, the housing having ports and terminals for hydraulic and electrical lines, for example. A control circuit board having an electronic control device may also be situated in the regulating module.

According to one specific embodiment of the present invention, the accumulator includes a spring element which is tensioned when the accumulator is filled, so that the spring element automatically empties the accumulator when the pressure in the accumulator drops. For example, the spring element may be a mechanical spring element, such as a helical spring or a leaf spring. The spring element may also be an elastically compressible body or a gas volume.

According to one specific embodiment of the present invention, the inlet valve is an electrical inlet valve, which closes when energized, for example. As long as the inlet valve is not supplied with electric current, it is (completely) open, and brake fluid is able to flow unimpaired between the brake actuating device and the wheel brake. When it is supplied with electric current, the inlet valve closes (completely), and the hydraulic connection between the brake actuating device and the wheel brake is interrupted.

According to one specific embodiment of the present invention, the outlet valve is an electrical outlet valve, which opens when energized, for example. As long as the outlet valve is not supplied with electric current, it is (completely) closed, and brake fluid is not able to flow out of or to the accumulator. When it is supplied with electric current, the outlet valve opens (completely), and (depending on the pressure gradient) brake fluid is able to flow out of the accumulator into the hydraulic connection, or out of the hydraulic connection into the accumulator.

According to one specific embodiment of the present invention, the hydraulic anti-lock braking system further includes an electronic control device, which is designed to activate the inlet valve and the outlet valve and to open and close them as a function of an ascertained locked state of one wheel of the two-wheeler. When the wheel does not lock up, the two valves may remain non-energized. If the wheel locks up, initially the inlet valve may be closed, and if needed the outlet valve may be opened.

According to one specific embodiment of the present invention, the control device is designed to receive signals from a position sensor of the brake actuating device and/or from a hydraulic pressure sensor in the hydraulic connection. These signals may be used to ascertain whether a rider of the two-wheeler intends to brake. For example, the rider may actuate a brake lever of the brake actuating device and change its position, which is then detected by the position sensor. As a result, a pressure of the brake fluid in the hydraulic connection increases, which is detectable by the pressure sensor.

According to one specific embodiment of the present invention, the control device is designed to receive signals from a rotational speed sensor on a wheel and, based thereon, determine a locked state of the wheel of the two-wheeler. The rotational speed sensor may be used to ascertain a wheel circumferential speed. If the same deviates from a reference speed of the two-wheeler, this indicates the locking of the wheel.

According to one specific embodiment of the present invention, the control device is designed to output signals to a signal lamp, which indicate whether the control device has identified a locked state. For example, the signal lamp may be switched off when the wheel does not lock up, and it may flash when the wheel locks up.

According to one specific embodiment of the present invention, the inlet valve, the outlet valve, and the accumulator are connected to a first hydraulic brake circuit for a first wheel of the two-wheeler. The two-wheeler may have separate brake circuits for the two wheels. The hydraulic anti-lock braking system may include a second inlet valve, a second outlet valve, and a second accumulator, which are connected to a second hydraulic brake circuit for a second wheel of the two-wheeler. The hydraulic anti-lock braking system may be used for the front wheel and/or the rear wheel. When it is used for both wheels, two independent regulating modules, or also one shared regulating module, may be used.

It is possible for the hydraulic anti-lock braking system to have an autonomous power supply unit (independently of a power supply unit of the two-wheeler). This power supply unit may be situated in the housing of the regulating module. The hydraulic anti-lock braking system may also be used in powered two-wheelers, which have an autonomous power supply unit directly in the hydraulic regulating module or outside thereof.

A further aspect of the present invention relates to a two-wheeler having a hydraulic anti-lock braking system, as it is described above and below. In addition to electrically driven two-wheelers, the anti-lock braking system may also be used in powered two-wheelers having an internal combustion engine, in particular for lightly powered two-wheelers, for example up to a maximum speed of 40 km/h (such as motorized bicycles or mopeds).

A further aspect of the present invention relates to a method for controlling a hydraulic anti-lock braking system for a two-wheeler. The method may be carried out using an anti-lock braking system as it is described above and below. For example, the method may be carried out by an electronic control device.

According to one specific embodiment of the present invention, the method includes the following steps: ascertaining whether a wheel of the two-wheeler locks up after a pressure was built by a rider, with the aid of a brake actuating device, in a hydraulic connection which connects the brake actuating device and a wheel brake for the wheel; closing an inlet valve to disconnect the hydraulic connection when the wheel locks up; ascertaining whether the wheel of the two-wheeler locked up when the inlet valve was closed; opening an outlet valve to accommodate brake fluid in an accumulator from the hydraulic connection between the inlet valve and the wheel brake; and keeping the outlet valve open to return brake fluid into the hydraulic connection between the inlet valve and the wheel brake with the aid of the accumulator after the rider has released the brake actuating device.

For example, based on the signals of the position sensor on the brake actuating device, the control device may identify that the rider has started to brake. It is also possible for the control device to ascertain this based on the signals of an alternative or additional pressure sensor, which ascertains the pressure in the hydraulic line between the brake actuating device and the inlet valve, for example.

Based on the signals of a rotational speed sensor, the control device is then able to ascertain whether or not the wheel is locking up. If the wheel locks up, the control device closes the inlet valve (at least partially), so that the pressure on the wheel brake is not able to rise, and thus the braking force also does not increase further.

If the wheel should still be locked up after the inlet valve has been closed, the control device may open the outlet valve (at least partially), and brake fluid may flow from the wheel brake into the accumulator, so that the pressure on the wheel brake decreases, and thus also the braking force is reduced. If the accumulator is full, the rider may further increase the braking force and thus trigger an intentional locking of the wheel.

A spring element may be situated in the accumulator, for example, which is contracted when the accumulator is filled and thus absorbs energy. This energy, which was effectively introduced into the system with the aid of the brake actuating device, for example by the rider, may be used to empty the accumulator again.

After the rider has released the brake actuating device, which may also be ascertained again by the control device with the aid of the position sensor and/or the pressure sensor, the outlet valve remains open until the accumulator has been emptied again, for example with the aid of the spring element.

It shall be understood that features of the method, as described above and below, may also be features of the anti-lock braking system, and vice versa.

### BRIEF DESCRIPTION OF THE DRAWINGS

FIG. 1 shows a schematic diagram of an anti-lock braking system according to one specific embodiment of the present invention.

FIG. 2 shows a schematic diagram of an anti-lock braking system according to a further specific embodiment of the present invention.

FIG. 3 shows a schematic diagram of a control device of an anti-lock braking system according to one specific embodiment of the present invention.

FIG. 4 shows a schematic diagram of a control device of an anti-lock braking system according to a further specific embodiment of the present invention.

FIG. 5 shows a diagram of a chronological progression of speeds and brake pressure, which explains a method for controlling a hydraulic anti-lock braking system according to one specific embodiment of the invention.

### DETAILED DESCRIPTION OF THE INVENTION

Identical or similar parts are denoted by the same reference numerals.

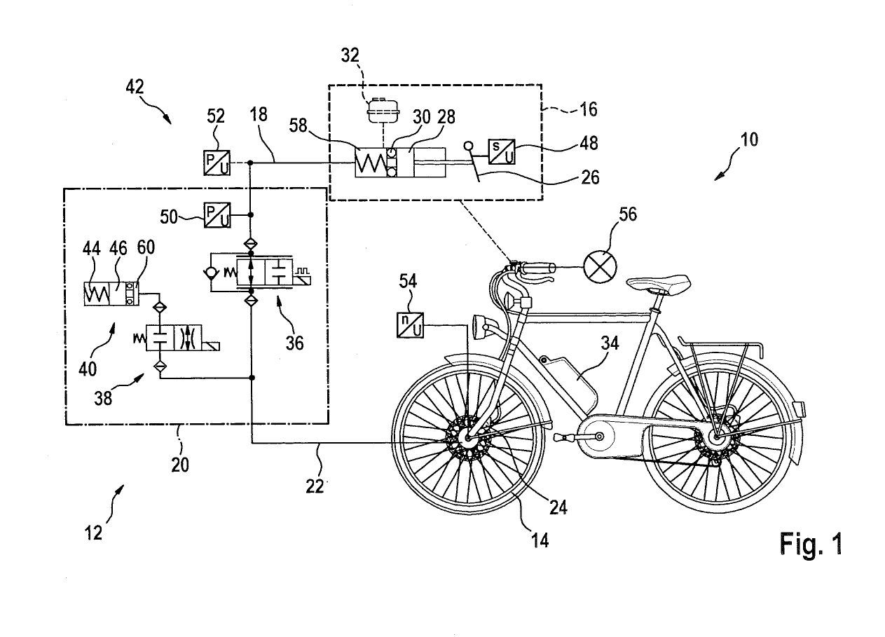

FIG. 1 shows a two-wheeler 10 having a hydraulic anti-lock braking system 12, which is designed to reduce a locking of the front wheel 14 of the two-wheeler.

The hydraulic components of anti-lock braking system 12 include a brake actuating device 16, which is connected via a first hydraulic line 18 to a regulating module 20, which is connected via a second hydraulic line 22 to a wheel brake 24. Wheel brake 24 includes a wheel brake cylinder, which presses brake shoes of the wheel brake against a brake disk or a wheel rim as a result of the hydraulic pressure.

Brake actuating device 16 includes a brake lever 26, a piston 28 having a seal 30, and optionally a reservoir 32 for brake fluid.

Regulating module 20, which together with electrical components may be attached in a housing 34 to two-wheeler 10, includes an inlet valve 36, an outlet valve 38, and an accumulator 40.

Inlet valve 36 is switched between first line 18 and second line 22 and connects or disconnects hydraulic connection 42, which is formed of two lines 18 and 22 between brake actuating device 16 and wheel brake 24. Inlet valve 36 may include a check valve, be open when de-energized, have filters on both sides and/or have a through-flow from both sides.

Outlet valve 38 is hydraulically connected to second line 22 and accumulator 40, i.e., is connected to hydraulic connection 42 between inlet valve 36 and wheel brake 24. Outlet valve 38 may be closed when de-energized, have filters on both sides and/or have a through-flow from both sides.

Accumulator 40 or intermediate accumulator 40 for brake fluid includes a spring element 44, for example a return spring 44, which tensions a piston 46 against the pressure of the brake fluid in line 22.

Brake actuating device 16 may [include] a path sensor 48 or a position sensor 48, which may be used to ascertain the instantaneous position of lever 26. Based on the position of lever 26, it is also possible to derive a pressure in first hydraulic line 18 and/or in hydraulic connection 42. As an alternative or in addition, it is also possible to use an internal hydraulic pressure sensor 50 or an external hydraulic pressure sensor 52 to ascertain the pressure in first hydraulic line 18 and/or in hydraulic connection 42, and based thereon optionally to derive the position of lever 26.

Internal hydraulic pressure sensor 50 may be an integral part of regulating module 20. External hydraulic pressure sensor 52 may be situated outside control module 20.

A rotational speed sensor 54 is attached to wheel 14 of two-wheeler 10 and may be used to ascertain the instantaneous rotational speed or the wheel circumferential speed of wheel 14. Rotational speed sensor 54 may include a toothed disk, which may be designed together with the brake disk, but alternatively may also be present as a separate part.

In addition to brake actuating device 16, a signal lamp 56 may be attached to the handlebar of two-wheeler 10, the signal lamp, as is described below, indicating to the rider of two-wheeler 10 when a control device of regulating module 20 identifies a locking of wheel 14.

When the rider of two-wheeler 10 actuates lever 26, a volume 58 (in a cylinder) is reduced by piston 30, so that brake fluid flows into first line 18 and from there (if inlet valve 36 is open) reaches second line 22 and wheel brake 24. When wheel brake 24 brakes wheel 14, the pressure in the lines increases. As is further described below, inlet valve 36 may be closed and outlet valve 38 may be opened when wheel 14 locks up. The pressurized brake fluid from second line 22 may then reach accumulator 40. A volume 60 (in a cylinder) is increased by the brake fluid displacing piston 46 against the force of spring element 44. In this way, the pressure on wheel brake 24 may be reduced, even though the rider actuates lever 26.

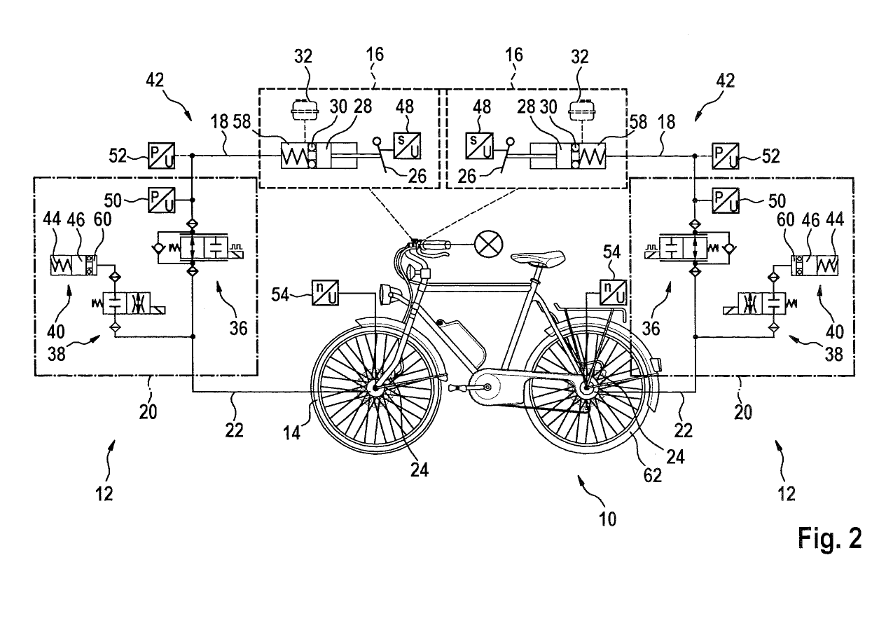

FIG. 2 shows a two-wheeler 10 having a hydraulic anti-lock braking system, which includes two brake circuits. The brake circuit for front wheel 14 is designed identically to the brake circuit shown in FIG. 1.

A further brake circuit for a rear wheel 62 may also be identical to the brake circuit shown in FIG. 1. The two brake circuits may be implemented with independent regulating modules 20, or with one shared control module (in a shared housing 34), for regulating wheel 14 and/or rear wheel 62.

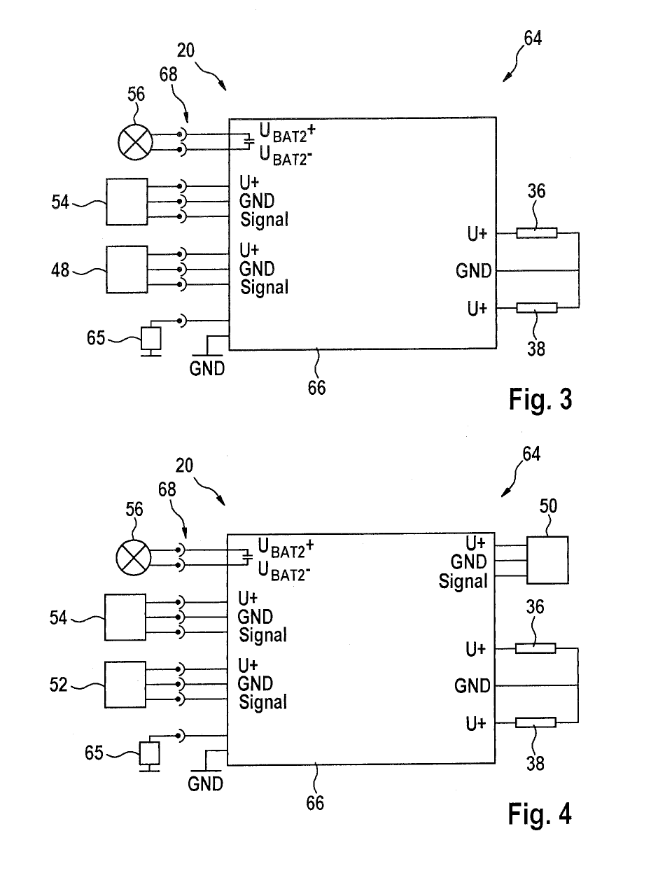

FIG. 3 shows further electrical control components of hydraulic anti-lock braking system 12. As is shown in FIG. 3, regulating module 20 may include an electronic control device 64, which may include a logic circuit on a printed circuit board 66, for example having a processor.

Regulating module 20 may include terminals 68 for signal lamp 56, rotational speed sensor 54, position sensor 48, and a power supply unit 65 (such as a battery of the two-wheeler). An autonomous power supply unit for regulating module 20 may be provided via an additional (internal) button cell.

Terminals 68 for regulating module 20 include supply pins and signal pins (plugs having external contacts) for ground (GND) for position sensor 48, voltage supply (U+) for position sensor 48 and for the signal from position sensor 48, and ground (U_{BAT2-}) for signal lamp 56 and voltage supply (U_{BAT2+}) for signal lamp 56.

An electrical connection or line from brake actuating device 16 to regulating module 20 may be connected to these terminals 68.

Terminals 68 for regulating module 20 further include supply pins and signal pins (plugs having external contacts), ground (GND) for rotational speed sensor 54, voltage supply (U+) for rotational speed sensor 54 and for the signal from rotational speed sensor 54. An electrical connection or line from rotational speed sensor 54 on wheel 14 to regulating module 20 may be connected to these terminals 68.

The regulating module further includes a terminal 68 for the ground (GN) of regulating module 20 and for power supply unit 65.

Printed circuit board 66 is moreover connected to inlet valve 36 and outlet valve 38 via internal lines in regulating module 20.

FIG. 4 shows an alternative specific embodiment for an electronic control device 64, in which regulating module 20 includes an internal pressure sensor 50. As an alternative or in addition, control device 64 may include a terminal 68 for an external pressure sensor 52.

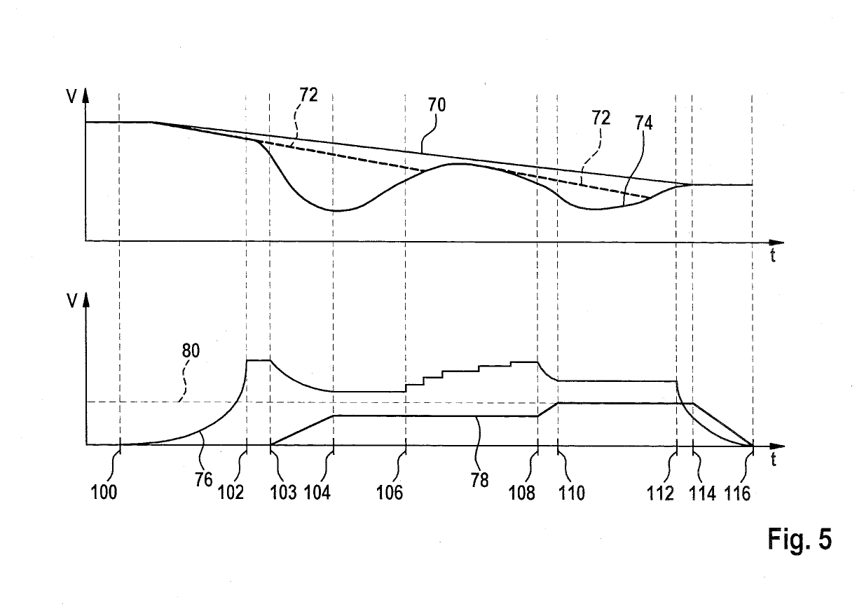

FIG. 5 shows a diagram in which speeds V are plotted against time t in an upper portion. The upper portion shows velocity 70 of two-wheeler 10, a reference speed 72 calculated by control device 64, and a wheel circumferential speed 74, which is ascertained by control device 64 based on the signal of rotational speed sensor 54.

Brake pressure 76 and fill volume 78 of accumulator 40 are plotted against time t in the lower portion. The upper portion and the lower portion show synchronous curves 70, 72, 74, 76, and 78.

The braking process shown in FIG. 5 begins by the rider actuating brake actuating device 16 (or lever 26) and building pressure in hydraulic connection 42 (point in time 100). Wheel brake 24 is thereby activated, and speed 70 of two-wheeler 10 is reduced.

With the aid of rotational speed sensor 54, control device 64 ascertains whether or not wheel 14 of the two-wheeler locks up. For this purpose, control device 64 calculates wheel circumferential speed 74 based on the signal of rotational speed sensor 54, and reference speed 74 based on the signal of position sensor 58 and/or the signal of pressure sensors 50, 52. The locked state of wheel 14 may be ascertained by comparing reference speed 74 to wheel circumferential speed 74.

During a braking process, during which wheel 14 continues to rotate or does not lock up (for example between point in time 100 and point in time 102), wheel circumferential speed 74 matches calculated reference speed 72, and inlet valve 36 and outlet valve 28 are not energized. Inlet valve 36 is then open, and outlet valve 28 is then closed. The speed is reduced as a result of the brake pressure in wheel brake 24. Since no locking of wheel 14 was ascertained, signal lamp 56 does not flash between points in time 100 and 102.

If the rider releases brake actuating device 16, the braking process is completed at this point. This may then be detected via position sensor 48, for example, and processed in regulating module 20.

When wheel 14 locks up, for example due to the high pressure or the low friction, control device 64 initially closes inlet valve 36 to disconnect hydraulic connection 42 (point in time 102). Signal lamp 56 flashes and visually indicates the regulation to the rider. The slip increases and the brake pressure is maintained between points in time 102 and 103.

When wheel 14 then continues to rotate (differently from the case shown) and wheel circumferential speed 74 again matches calculated reference speed 72, inlet valve 36 is no longer energized and opens again. Signal lamp 56 stops flashing and visually indicates to the rider that the regulation has ended.

Even when inlet valve 36 is closed, the control device continues to ascertain whether wheel 14 of two-wheeler 12 locks up. If wheel 14 is still locked up after some time (point in time 103), or wheel circumferential speed 74 does not yet match reference speed 72 of wheel 14, control device 64 opens outlet valve 48 to accommodate brake fluid in accumulator 40 from hydraulic connection 42 between inlet valve 36 and wheel brake 24. A pressure reduction takes place in wheel brake 24, and brake fluid from the brake circuit is accommodated in accumulator 40. Fill volume 78 of accumulator 40 increases.

A pressure reduction thus takes place in wheel brake 24 between points in time 103 and 104.

At point in time 104, control device 64 closes outlet valve 38 again. Since the inlet valve is still closed, the pressure is maintained. Wheel 14 accelerates again between points in time 104 and 196.

When wheel circumferential speed 74 again approaches reference speed 72, control device 64 may briefly open inlet valve 36 to enable a pressure buildup on wheel brake 24. This may be carried out in a gradual pressure buildup, for example as shown between points in time 106 and 108.

A renewed pressure reduction is shown between points in time 108 and 110, during which volume 60 of accumulator 40 is filled completely up to a maximal volume 80. Since wheel 14 locks up again, even though inlet valve 36 is closed, control device 64 opens outlet valve 38 again. The regulation continues until volume 60 in accumulator 40 has been completely filled.

The hydraulic circuit is designed in such a way that volume 58 in brake actuating device 16 is greater than volume 60 in accumulator 40. It is thus ensured that braking continues to be possible with a completely filled accumulator 40 after a pressure reduction. Wheel 14 may then lock up when a corresponding rider input and friction (for example in the event of ice or stone chips) occur.

The pressure is then maintained between points in time 110 and 112, and the braking process is ended after the rider has released brake actuating device 16.

After the rider has released brake actuating device 16 (point in time 112), control device 64 keeps outlet valve 48 open in order to return brake fluid into hydraulic connection 42 between inlet valve 36 and wheel brake 24. Accumulator 40 accomplishes this automatically with the aid of spring element 44 tensioned by the pressure. The spring force of accumulator 40 pushes the volume accommodated during the regulation back into the brake circuit via energized outlet valve 38. Accumulator 40 is completely emptied between points in time 114 and 166, during which the pressure in the hydraulic line has dropped below the pressure in accumulator 40. The level in optionally present brake fluid container 32 rises.

In the event of a fault, for example when the rechargeable battery or power supply unit 65, control device 64 and/or regulating module 20 (a valve 26, 38, for example) is/are defective, signal lamp 56 is permanently illuminated and indicates to the rider that one of the above-described defects has occurred.

In addition, it shall be pointed out that “including” does not exclude other elements or steps, and that “a” or “an” does not exclude a plurality. It shall moreover be pointed out that features or steps which were described with reference to one of the above-mentioned exemplary embodiments may also be used in combination with other features or steps of other above-described exemplary embodiments. Reference numerals in the claims shall not be regarded as limiting.

1-11. (canceled)

12. A hydraulic anti-lock braking system for a two-wheel vehicle, comprising:
a first inlet valve for connecting and disconnecting a hydraulic connection between a brake actuating device and a wheel brake;
a first accumulator for accommodating brake fluid from the hydraulic connection between the first inlet valve and the wheel brake; and
a first outlet valve for selectively connecting and disconnecting the first accumulator to and from the wheel brake, wherein the first accumulator is configured to return brake fluid into the hydraulic connection between the first inlet valve and the wheel brake.

13. The hydraulic anti-lock braking system as recited in claim 12, wherein the first accumulator includes a spring element which is tensioned when the accumulator is filled, and wherein the spring element automatically empties the first accumulator when the pressure in the first accumulator drops.

14. The hydraulic anti-lock braking system as recited in claim 13, wherein the first inlet valve is an electrical inlet valve which closes when energized.

15. The hydraulic anti-lock braking system as recited in claim 13, wherein the first outlet valve is an electrical outlet valve which opens when energized.

16. The hydraulic anti-lock braking system as recited in claim 13, further comprising:
an electronic control device configured to selectively activate the first inlet valve and the first outlet valve and to selectively open and close the first inlet valve and the first outlet valve as a function of an ascertained locked state of a wheel of the two-wheeler.

17. The hydraulic anti-lock braking system as recited in claim 16, wherein the control device is configured to receive signals from at least one of a position sensor of the brake actuating device and a hydraulic pressure sensor in the hydraulic connection.

18. The hydraulic anti-lock braking system as recited in claim 16, wherein the control device is configured to (i) receive signals from a rotational speed sensor on a wheel of the two-wheel vehicle, and (ii) determine a locked state of the wheel based on the signals from the rotational speed sensor.

19. The hydraulic anti-lock braking system as recited in claim 16, wherein the control device is configured to output at least one signal to a signal lamp, the at least one signal indicating whether the control device has identified a locked state.

20. The hydraulic anti-lock braking system as recited in claim 16, further comprising:
a second inlet valve;
a second outlet valve; and
a second accumulator;
wherein the first inlet valve, the first outlet valve, and the first accumulator are connected to a first hydraulic brake circuit for a first wheel of the two-wheel vehicle, and wherein
the second inlet valve, the second outlet valve, and the second accumulator are connected to a second hydraulic brake circuit for a second wheel of the two-wheeler.

21. A method for controlling a hydraulic anti-lock braking system for a two-wheel vehicle, comprising:
ascertaining whether a wheel of the two-wheel vehicle has locked after a pressure build-up in a hydraulic connection initiated by a rider with the aid of a brake actuating device, wherein the hydraulic connection connects the brake actuating device and a wheel brake for the wheel;
closing an inlet valve to disconnect the hydraulic connection when the wheel has locked;
ascertaining whether the wheel of the two-wheel vehicle is locked when the inlet valve is closed;
opening an outlet valve to accommodate brake fluid in an accumulator from the hydraulic connection between the inlet valve and the wheel brake; and
maintaining the outlet valve open to return brake fluid into the hydraulic connection between the inlet valve and the wheel brake with the aid of the accumulator after the rider has released the brake actuating device.
